(19) United States
(12) Patent Application Publication
(10) Pub. No.: US 2017/0364899 A1
(43) Pub. Date: Dec. 21, 2017

(54) UNBANKED SAFELOAD

(71) Applicant: Diebold Nixdorf, Incorporated, North Canton, OH (US)

(72) Inventors: Devon WATSON, North Canton, OH (US); Douglas Kurt HARTUNG, Kingwood, TX (US); Gary A. GANGER, Uniontown, OH (US); Gregory SHIMEK, Akron, OH (US); Vanessa GAGNON, Stow, OH (US)

(21) Appl. No.: 15/624,165

(22) Filed: Jun. 15, 2017

Related U.S. Application Data
(60) Provisional application No. 62/350,390, filed on Jun. 15, 2016.

(51) Int. Cl. G06Q 20/32; G06Q 20/10; G06Q 20/20; G06Q 20/40

(52) U.S. Cl. CPC G06Q 20/3223; G06Q 20/405; G06Q 20/4014; G06Q 20/1085; G06Q 20/202; G06Q 20/3278

(57) ABSTRACT

A system having a payment-credential logic; a software application; wherein when an authorized person verifies an identity of a mobile customer using a government identification document, the payment-credential logic is then activated, the payment-credential logic is configured to create payment-credential information and to cause the payment-credential information to be stored for future access, wherein the payment-credential logic is configured to provide a way for the software application to be loaded into a mobile customer device, wherein the software application is configured to allow the mobile customer device to access the payment-credential information for one or more future monetary transactions.

### CROSS-REFERENCE TO RELATED APPLICATIONS

This patent application claims priority to provisional patent application serial number U.S. 62/350,390 that was filed on Jun. 15, 2016. The entire subject matter of the provisional patent application is incorporated herein by reference.

### BACKGROUND OF THE INVENTION

Various configurations of the current invention relate generally to apparatus, systems, and methods allowing a customer without a banking account to create and store information related to banking. More particularly, the apparatus, systems and methods allow customers to use a personal mobile device to conduct banking transactions.

### DESCRIPTION OF RELATED ART

People in many places of the world still do not have banking accounts. These people generally conduct all financial transactions in cash. Without having a bank account it may be difficult to pay for some purchases such as online internet purchases. It may also be difficult to transfer money to a relative or another person at a distant location. There remains a need for better methods and systems for executing financial transactions.

### SUMMARY OF THE INVENTION

A system for creating payment-credential information and allowing it to be used to make electronic payments includes a payment-credential logic and a software application. When an authorized person, such as a bank teller, verifies the identity of a customer using a government identification document, the payment-credential logic is activated by the authorized person to create payment-credential information and to cause the payment-credential information to be stored for future access. The payment-credential logic also causes the software application to be loaded into the mobile customer device to allow the mobile customer device to access the payment-credential information for one or more future monetary transactions.

Another embodiment is a financial-banking system having a payment-credential machine and a server. The payment-credential machine operates to accept inputs from a banking representative that represents a currency to be stored in a mobile device of the person. The payment-credential machine accepts inputs representative of a unique identifier of the mobile device of the person. A server receives the unique identifier of the mobile device and generates payment-credential information associated with the unique identifier. A server provides for a way to download a software application onto the mobile device. The software provides a way to use the payment-credential information to facilitate a financial transaction using the mobile device.

One embodiment is a method of creating payment-credential information. The method begins by receiving a person's mobile-phone number at a server or another computing device. In some embodiments, the person would go to a location with some security and present some form of identification (ID) such as a government-issued ID. An authorized person such as a bank representative would verify the person presenting the ID is who they say they are. The authorized person would then initialize the creation of payment-credential information associated with the mobile-phone number. The authorized person may only begin creating the payment-credential information upon receiving funds from the customer, as discussed below. A message is sent from a server to the person's mobile-phone. The message contains information allowing access to the payment-credential information. As discussed earlier, the message may indicate how to download a software application to the customer's phone. The software application provides a way for the customer to access the payment-credential information stored on their phone and/or a remote secured server.

A system having a payment-credential logic; a software application; wherein when an authorized person verifies an identity of a mobile customer using a government identification document, the payment-credential logic is then activated, the payment-credential logic is configured to create payment-credential information and to cause the payment-credential information to be stored for future access, wherein the payment-credential logic is configured to provide a way for the software application to be loaded into a mobile customer device, wherein the software application is configured to allow the mobile customer device to access the payment-credential information for one or more future monetary transactions.

A method of creating and using a payment-credential information having the steps of receiving a person's mobile-phone number at one of at least one server after the person's identity has been authenticated using a government-issued identification (ID); at one of the at least one server, creating payment-credential information associated with the mobile-phone number, wherein the payment-credential information provides a way to make electronic payments; and sending a message from one of the at least one servers to the person's mobile-phone, wherein the message contains information allowing access to the payment-credential information.

A financial-banking system having at least one payment-credential machine operable to accept inputs representative of a unique identifier of a mobile customer device of a customer after an authorized person verifies the identity of the customer; and at least one server configured to receive the unique identifier of the mobile customer device and to create payment-credential information associated with the unique identifier, wherein one of the at least one server is configured to provide for a way to download a software application to the mobile customer device to allow the software application to facilitate a financial transaction from the mobile customer device.

### BRIEF DESCRIPTION OF THE SEVERAL VIEWS OF THE DRAWING(S)

The accompanying drawings, which are incorporated in and constitute a part of the specification, illustrate various example methods and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example system for creating payment-credential information for an unbanked customer.

FIG. 2 illustrates an example of payment-credential information and some of its contents.

FIG. 3 illustrates an example embodiment of a customer using his mobile customer device to make an electronic payment at a point of sale (POS) device.

FIG. 4 is an example flow diagram illustrating an embodiment of a method of creating payment-credential information for an unbanked customer.

FIG. 5 is an example computing environment in which various embodiments or portions of embodiments may operate.

### DETAILED DESCRIPTION OF THE INVENTION

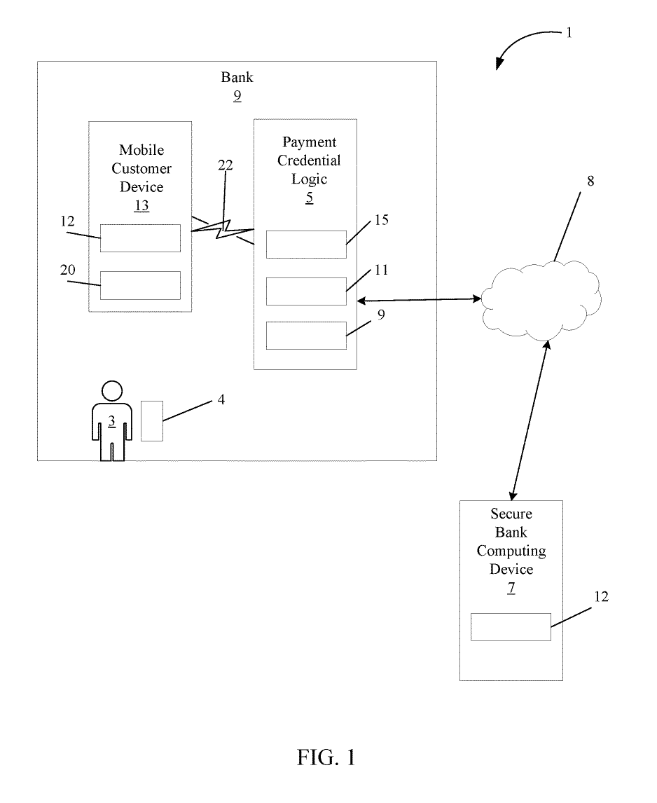

In many places in the world, people do not have bank accounts and use cash for many transactions. Without a bank account, it may be difficult and costly to transfer money between two different locations. FIG. 1 illustrates one example embodiment of an unbanked customer system 1 for “unbanked safeloading.” Unbanked safeloading provides a way to have funds transferred to a personal mobile customer device such as a cellphone to allow that person to use their cellphone to perform many functions traditionally performed with banking accounts. For example, that person may make payments at stores using their phone, may make payments over the internet and perform other traditional banking transactions using their phone. In some embodiments, the phone would operate similar to a prepaid credit or debit card with similar credentials to the prepaid debit or credit card stored in the phone and associated with an account on a trusted bank server. Thus, unbanked safeloading of loading credit into a personal electronic device or phone, without the need to open a formal bank account, is an effective solution for unbanked customers.

Details are set forth in the following description and in FIGS. 1-5 to provide a thorough understanding of various embodiments of the invention. Those of ordinary skill in the art will understand that the example embodiments may have additional components and configurations that may be practiced without several of the details described below. In some instances, persons of ordinary skill in the art will appreciate that the methods and systems described herein can include additional details without departing from the spirit or scope of the disclosed embodiments. Additionally, some known structures and systems associated with automated transaction machines (ATMs), mobile devices, and associated computer networks have not been shown or described in detail below to avoid unnecessarily obscuring the described embodiments.

FIG. 1 illustrates an unbanked customer system 1 for unbanked safeloading for loading payment-credentials into a mobile customer device 13. The system 1 includes a payment-credential logic 5, a software application 20 and in some embodiments one or more remote bank computing devices 7 (i.e. servers). The mobile customer device 13 may be a mobile device such as cellphone, a touch pad, a laptop, and the like. The payment-credential logic 5 is preferably located in an at least a partially secure area such as at a bank 9 or possibly inside a retail establishment, to provide ease of access and a sense of security when uploading the payment-credential information 12 onto the mobile customer device 13. In some embodiments, the payment-credential logic 5 may be connected to one or more networks 8, in some embodiments including the internet so that signals traveling between the remote bank computing device 7 and the payment-credential logic 5 will travel through those networks 8 before reaching the remote bank computing device 7.

Additionally, functionality of components of the systems described herein may be implemented with one or more processors executing software instructions and/or be implemented with other hardware logic. “Processor” and “Logic”, as used herein, includes but is not limited to hardware, firmware, software and/or combinations of each to perform a function(s) or an action(s), and/or to cause a function or action from another logic, method, and/or system. For example, based on a desired application or needs, logic and/or processor may include a software-controlled microprocessor, discrete logic, an application specific integrated circuit (ASIC), a programmed logic device, a memory device containing instructions or the like. Logic and/or processor may include one or more gates, combinations of gates, or other circuit components. Logic and/or a processor may also be fully embodied as software. Where multiple logics and/or processors are described, it may be possible to incorporate the multiple logics and/or processors into one physical logic (or processors). Similarly, where a single logic and/or processor is described, it may be possible to distribute that single logic and/or processor between multiple physical logics and/or processors.

Initially, a customer 3 would enter a location such as a bank 9 that has the payment-credential logic 5. Customer 3 would then present some form of customer identification 4 that verifies their identity. For example, the form of customer identification 4 may be government-issued ID that contains their picture. An authorized person, such as a bank customer representative, would then verify the customer 3 based on the customer identification 4 provided. Once the customer 3 is verified, they may present an amount of cash or another form of currency to the bank 9. In an alternate embodiment, verification is performed by taking a real-time photograph of the customer and using known computer algorithms to compare the real-time photo with the government-issued ID photo; if the algorithm makes a determination that the real-time photo matches the government-issued photo, then the authorized person will then conclude that the customer's identity is verified.

The bank 9 will then use the payment-credential logic 5 to download a software application 20 onto the mobile customer device 13. This may be performed wirelessly 22 using near field communication (NFC), or by attaching a cable between the mobile customer device 13 and the payment-credential logic 5, or in another way as understood by those of ordinary skill in the art. For example, in some embodiments, the software download may originate at a remote bank computing device 7 (e.g., a server) and may be downloaded by, at least in part, using cellular and/or other wide-area RF communications. In other embodiments, a link to the software application may be sent to the mobile customer device 13 to allow it to be downloaded using the link. In embodiments, a one-time security code is sent from a remote server to the mobile customer device so that the customer can provide the security code to the authorized person and thereby ensure that the correct mobile phone number has been input. In an additional embodiment, the one-time security code acts as a secondary form of customer-identity verification.

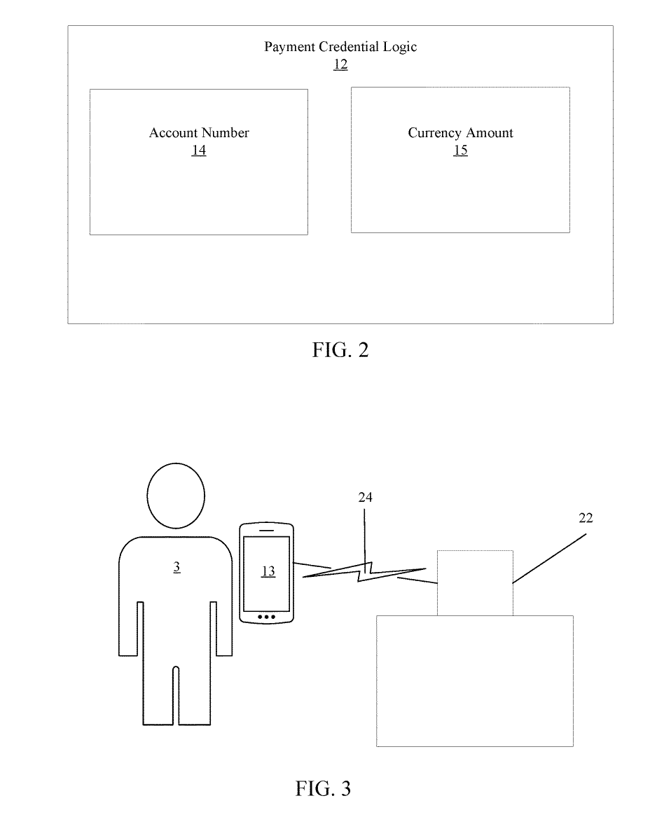

The payment-credential logic 5 places the payment-credential information 12, or representations thereof, onto the mobile customer device 13. The payment-credential information 12 may contain a currency amount 15 (FIG. 2) equal to the cash amount the customer 3 presented to the bank 9 or less a fee to the bank 9 for loading the payment-credential information 12. In some configurations, an account number 14 (FIG. 2) portion of the payment-credential information 12 may also be created. In some embodiments, the payment-credential information 12 is also loaded onto a remote banking server (secure bank computing device 7). When the payment-credential information 12 is loaded onto a remote server 7, the mobile customer device 13 may operate similar to a prepaid credit or debit card, as understood by those of ordinary skill in the art. In embodiments, the account can be loaded or funded in known manners methods for making check deposits, cash deposits, or combinations thereof.

The customer 3 may not be aware that an “account” has been created but the account number 14 may also, in some embodiments, be stored on the remote server (remote bank computing device 7). An account number 14 may be useful to track how much and when currency amounts represented by the payment-credential information 12 are used to make purchases or are used in other fund transfers as described below. In some embodiments, the payment-credential information 12 and/or the account number 14 may contain a phone number of a mobile phone when a mobile phone is used as the mobile customer device 13. In other embodiments, the payment-credential information 12 and/or the account number 14 may contain the media access control (MAC) and/or another number of a mobile customer device 13. Additionally, some portion of the customer identification 4 may be included as part of the account number 14 and/or payment-credential information 12. The payment-credential information 12 may contain personal information such as the customer's address and other information allowing for electronic payment using the mobile customer device 13.

Having described the unbanked customer system 1, its use and functionality is now presented. In one embodiment, when the customer 3 uses his/her mobile customer device 13 to make an electronic payment at a point of sale (POS) 22 (FIG. 3), or any device that accepts electronic payments, he/she would open the software application 20 to a payment window and key in an amount for the payment. The customer would also specify where the payment is to be sent. Next, they would hit “send” and the mobile customer device 13 would (in one embodiment) send electronic payment to a POS terminal 22 or another device using NFC 24 or another communication link as understood by those of ordinary skill in the art. The electronic payment/message may travel to a merchant banking account that is to be paid. In some embodiments, the software application 20 may also generate a purchase-credential updated message that would travel to a remote bank computing device 7 (e.g., server) where the amount of payment would be removed from the amount of available currency represented in the currency amount 15 portion of payment-credential information 12 at that remote server 7. Sending the purchase-credential updated message to the remoter server 7 in this embodiment allows the mobile customer device to operate as and appear as a prepaid debit or credit card. The software application 20 may present a screen on the cellphone showing the remaining balance. Of course, the customer 3 may return to a bank or depository location with cash, or other monetary instruments, to have funds added to the currency amount 15 portion of the payment-credential information 12.

In other embodiments, the payment-credential information 12 may only be stored locally on the mobile customer device 13 and not on a remote server 7. However, in these embodiments, transaction records associated with the payment-credential information 12 will be stored in a trusted environment to prevent fraudulent transactions. The trusted environment may be one or more secure banking servers 7. In this case, the software application 20 on the mobile customer device 13 would deduct payments from the payment-credential information 12 each time it was used to conduct a transaction. For example, the customer 3 may have had their phone and its payment-credential information 12 loaded with 100 tokens that represent 100 dollars deposited at the bank 9. If the customer 3 were to later purchase something at a retail establishment for 12 dollars, then 12 tokens would be transferred from the phone to the retail establishment. Soon after the transaction or several days later, the retail establishment could send their tokens to the bank 9 to convert the tokens into dollars owned by the retail establishment. Thus, in this embodiment, the payment-credential information 12 essentially may reside only on the phone with available credit represented by tokens or another monitory variable as understood by those of ordinary skill in the art.

In other embodiments, different tokens may represent each penny or the smallest monitory unit contained in the payment-credential information 12. In yet other embodiments, if a customer purchases something costing 12.20 dollars then the retail establishment would collected 13 tokens from the customer's phone and return $0.80 to the customer in change.

In some embodiments, the payment-credential information 12 may preferably be encrypted on the mobile customer device 13 using a block cyphers, hash algorithms and/or in another way as known by those of ordinary skill in the art. This provides a level of security. In other embodiments the software application 20 would be password and/or personal identification number (PIN) number protected. In other embodiments, the payment-credential logic 5 and/or mobile customer device may include an iris scan input, fingerprint and/or another biometric input that is unique to that customer. Only those knowing the password or PIN or having the correct biometric feature may access the software application 20 to access the payment-credential information 12 for making a purchase.

In some embodiments the unbanked customer system 1 may be used to transfer funds from one person to a remote person and also perform other banking functions as understood by those of ordinary skill in the art. And in an embodiment generally directed to enabling the transfer funds from one person to another, both the sender's and the receiver's phones will be configured with software logic that facilitates the transfer of funds from the sender's account balance to the recipient's account balance in a manner that would effectively function similar to a transfer of funds from a pre-paid credit or debit card to a third-party account.

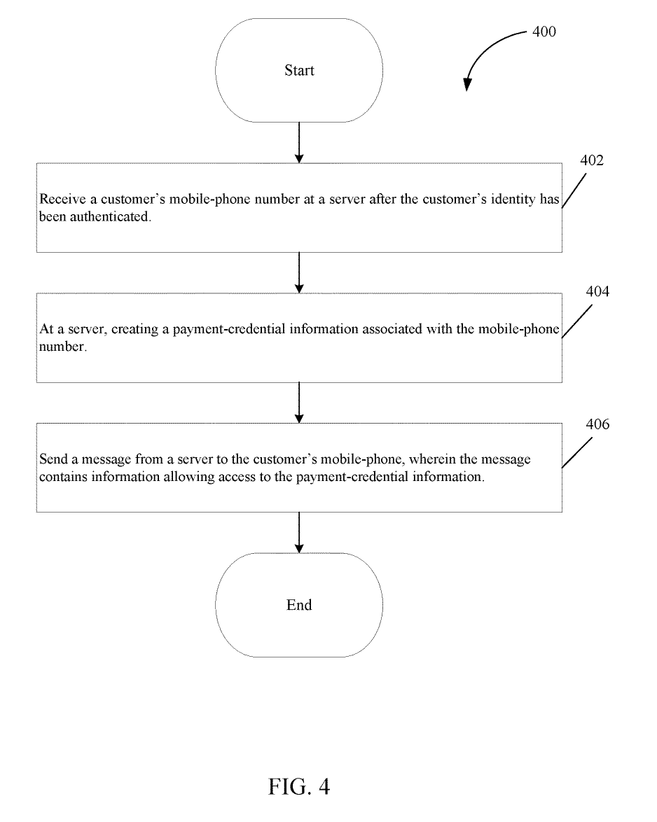

The functionality of the example system of FIG. 1 will be further explained with reference to an example method and the flow diagram of FIG. 4. While for purposes of simplicity, explanation of the illustrated methodologies are shown and described as a series of blocks. It is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

FIG. 4 illustrates a method 400 of creating payment-credential information. The method 400 begins, at 402, by receiving a person's mobile-phone number at a server or another computing device. In some embodiments, the person would go to a location with some security and present some form of identification (ID) such as a government-issued ID. An authorized person such as a bank representative would verify the person presenting the ID is who they say they are. The authorized person would then, at 404, initialize the creation of a payment-credential information associated with the mobile-phone number. The authorized person may only begin creating the payment-credential information upon receiving funds from the customer, as discussed earlier. A message is sent from a server to the person's mobile-phone, at 406. The message contains information allowing access to the payment-credential information. As discussed earlier, the message may indicate how to download a software application to the customer's phone. The software application provides a way for the customer to access the payment-credential information stored on their phone and/or a remote secured server as previously discussed.

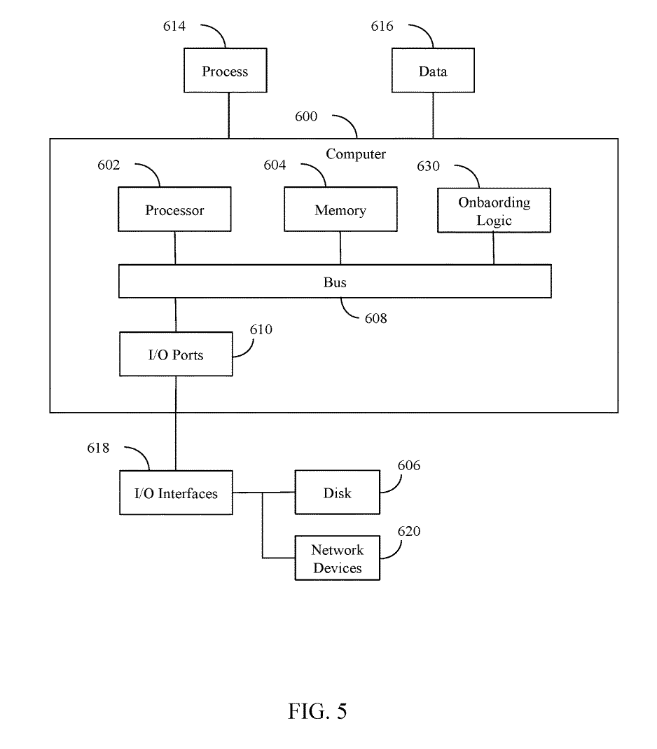

FIG. 5 illustrates an example computing device in which example systems and methods described herein, and equivalents, may operate. The example computing device may be a computer 600 that includes a processor 602, a memory 604, and input/output ports 610 operably connected by a bus 608. In one example, the computer 600 may include a purchase-credential logic 630 configured to assist a customer in loading payment-credential information into their mobile device. In different examples, purchase-credential logic 630 may be implemented in hardware, software, firmware, and/or combinations thereof. Thus, purchase-credential logic 630 may provide means (e.g., hardware, software, firmware) to assist a customer in loading payment-credential information into their mobile device. While the purchase-credential logic 630 is illustrated as a hardware component attached to bus 608, it is to be appreciated that in one example, the purchase-credential logic 630 could be implemented in processor 602.

Generally describing an example configuration of computer 600, processor 602 may be a variety of various processors including dual microprocessor and other multi-processor architectures. Memory 604 may include volatile memory and/or non-volatile memory. Non-volatile memory may include, for example, ROM, PROM, EPROM, and EEPROM. Volatile memory may include, for example, RAM, synchronous RAM (SRAM), dynamic RAM (DRAM), synchronous DRAM (SDRAM), double data rate SDRAM (DDR SDRAM), direct RAM bus RAM (DRRAM) and the like.

A disk 606 may be operably connected to computer 600 via, for example, an input/output interface (e.g., card, device) 618 and input/output ports 610. Disk 606 may be, for example, a magnetic disk drive, a solid state disk drive, a floppy disk drive, a tape drive, a Zip drive, a flash memory card, and/or a memory stick. Furthermore, disk 606 may be a compact disk-read only memory (CD-ROM), a CD recordable drive (CD-R drive), a CD rewriteable drive (CD-RW drive), and/or a digital video ROM drive (DVD ROM). Memory 604 can store a process 614 and/or a data 616, for example. Disk 606 and/or memory 604 can store an operating system that controls and allocates resources of computer 600.

Bus 608 may be a single internal bus interconnect architecture and/or other bus or mesh architectures. While a single bus is illustrated, it is to be appreciated that computer 600 may communicate with various devices, logics, and peripherals using other busses (e.g., PCIE, SATA, Infiniband, 1384, universal serial bus (USB), Ethernet). Bus 608 can be types including, for example, a memory bus, a memory controller, a peripheral bus, an external bus, a crossbar switch, and/or a local bus.

Computer 600 may interact with input/output devices via input/output interfaces 618 and input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, USB ports and the like.

The computer 600 can operate in a network environment and thus may be connected to network devices 620 via input/output interfaces 618, and/or the input/output ports 610. Through network devices 620, computer 600 may interact with a network. Through the network, computer 600 may be logically connected to remote computers. Networks with which computer 600 may interact include, but are not limited to, a local area network (LAN), a wide area network (WAN), and other networks. The networks may be wired and/or wireless networks.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example” and so on, indicate that the embodiment(s) or example(s) so described may include a particular feature, structure, characteristic, property, element, or limitation, but that not every embodiment or example necessarily includes that particular feature, structure, characteristic, property, element, or limitation.

What is claimed is:

1. A system comprising:
a payment-credential logic;
a software application;
when an authorized person verifies an identity of a mobile customer using a government identification document, the payment-credential logic is then activated, the payment-credential logic is configured to create payment-credential information and to cause the payment-credential information to be stored for future access, wherein the payment-credential logic is configured to provide a way for the software application to be loaded into a mobile customer device, wherein the software application is configured to allow the mobile customer device to access the payment-credential information for one or more future monetary transactions.

2. The system of claim 1 wherein the payment-credential logic is configured to cause the payment-credential information to be encrypted in the mobile customer device.

3. The system of claim 1 further comprising:
a server, wherein the payment-credential logic is configured to cause the payment-credential information to be stored on the server.

4. The system of claim 1 wherein the government identification document is a government identification (ID) card with a photograph of the customer.

5. The system of claim 1 wherein the software application is configured to at least allow a monetary value to be added to the payment-credential information, and wherein the software application is configured to at least allow for a removal of at least a portion of the monetary value from the payment-credential information.

6. The system of claim 5 further comprising:
a monetary transfer device wherein at least part of the monetary value is removed from the payment-credential information by the monetary transfer device.

7. The system of claim 6 wherein the monetary transfer device is selected from one of the group of an automatic transaction machine (ATM), a merchandise checkout machine and a point of sale (POS) device.

8. The system of claim 1 wherein the mobile customer device is at least one of the group consisting of: a mobile phone, a laptop computer and a mobile touchpad device.

9. The system of claim 8 wherein an identifier of the mobile customer device is at least one of the group consisting of: a phone number and a MAC address, and wherein the identifier is stored in the payment-credential information.

10. The system of claim 1 wherein the payment-credential logic is located in one of the group consisting of in a bank and in a retail establishment.

11. The system of claim 1 wherein the payment-credential logic is located in one of the group consisting of a computer, a server and part of a POS device.

12. The system of claim 1 wherein the payment-credential logic wirelessly communicates with the mobile customer device.

13. A method of creating and using a payment-credential information comprising:
receiving a person's mobile-phone number at one of at least one server after the person's identity has been authenticated using a government-issued identification (ID);
at one of the at least one server, creating payment-credential information associated with the mobile-phone number, wherein the payment-credential information provides a way to make electronic payments; and
sending a message from one of the at least one servers to the person's mobile-phone, wherein the message contains information allowing access to the payment-credential information.

14. The method of creating and using a payment-credential information of claim 13 further comprising:
sending a one-time verification code message from one of the at least one server to the person's mobile phone, wherein the message contains a code that can be used to verify that the person has provided to correct mobile phone number.

15. The method of creating and using a payment-credential information of claim 13 further comprising:
funding the payment-credential information based at least in part on a check deposit, a cash deposit, or a combination thereof.

16. The method of creating and using a payment-credential information of claim 13 further comprising:
comparing a facial image from a governmental-issued identification (ID) with a digital photograph of the person that was taken at approximately the time of authentication.

17. The method of creating and using a payment-credential information of claim 13 further comprising:
receiving at the person's mobile-phone from one of the at least one servers a request to fund the payment-credential information; and
funding the payment-credential information based, at least in part, on receiving the request from one of the at least one server.

18. The method of creating and using a payment-credential information of claim 13 further comprising:
sending to the person's mobile-phone from one of the at least one server a request to pay a utility bill; and
initiating a payment from the mobile-phone paying the utility bill based on the payment-credential information.

19. The method of creating and using a payment-credential information of claim 18 further comprising:
at the one of the at least one of server, reducing a value of the payment-credential information corresponding to an amount of the utility bill.

20. The method of creating and using a payment-credential information of claim 13 further comprising:
receiving at one of the at least one server a request to pay a third party, and
paying the third party using the payment-credential information.

21. A financial-banking system comprising:
at least one payment-credential machine operable to accept inputs representative of a unique identifier of a mobile customer device of a customer after an authorized person verifies the identity of the customer; and
at least one server configured to receive the unique identifier of the mobile customer device and to create payment-credential information associated with the unique identifier, wherein one of the at least one server is configured to provide for a way to download a software application to the mobile customer device to allow the software application to facilitate a financial transaction from the mobile customer device.

22. The financial-banking system of claim 21, wherein the financial transaction is at least one selected from the group consisting of adding a first financial amount to the payment-credential information, removing a second financial amount from the payment-credential information, and transferring a third financial amount from the payment-credential information to a different financial account.

23. The financial-banking system of claim 21, wherein the mobile customer device is a phone with a phone number and the payment-credential information is based, at least in part, on the phone number.
